(19) United States
(12) Patent Application Publication
(10) Pub. No.: US 2025/0316266 A1
(43) Pub. Date: Oct. 9, 2025

(54) Method and Apparatus for Controlling Speech Recognition Device, Electronic Device, and Storage Medium

(71) Applicants: Gree Electric Appliances, Inc. of Zhuhai, Zhuhai, Guangdong (CN); Zhuhai Leayun Technology Co., Ltd, Zhuhai City, Guangdong (CN)

(72) Inventors: Xiaobo HAO, Zhuhai, Guangdong (CN); Shaobin LI, Zhuhai, Guangdong (CN); Dechao SONG, Zhuhai, Guangdong (CN); Jie TANG, Zhuhai, Guangdong (CN); Peng ZHANG, Zhuhai, Guangdong (CN)

(21) Appl. No.: 18/863,308

(22) PCT Filed: Dec. 21, 2022
(86) PCT No.: PCT/CN2022/140746

§ 371 Date: Nov. 5, 2024

(30) Foreign Application Priority Data
Jun. 21, 2022 (CN) 202210708640.2

(51) Int. Cl. G10L 15/22; G10L 15/08; G10L 15/25

(52) U.S. Cl. CPC G10L 15/22; G10L 15/08; G10L 15/25; G10L 2015/088; G10L 2015/227

(57) ABSTRACT

Disclosed are a method and apparatus for controlling a speech recognition device, an electronic device, and a storage medium. The method includes: recording, when the speech recognition device is in a dormant state, current time as first time in response to detecting that a target object stares at the speech recognition device; recording the current time as second time in response to detecting that the target object makes a speech; and awakening the speech recognition device in response to determining that an interval between the first time and the second time satisfies a preset condition, such that the speech recognition device enters a speech control mode.

The disclosure claims the priority to Chinese Patent Application No. 202210708640.2, filed with the Chinese Patent Office on Jun. 21, 2022 and entitled “Method and apparatus for controlling speech recognition device, electronic device, and storage medium”, which is incorporated in its entirety herein by reference.

### TECHNICAL FIELD

The disclosure relates to a technical field of artificial intelligence, and particularly relates to a method and apparatus for controlling a speech recognition device, an electronic device, and a storage medium.

### BACKGROUND

With development of the Internet of Things technology and emergence of various speech devices, personal life experience has been greatly broadened. However, a speech-enabled service device can only start after awakened through a keyword, and then transmit a corresponding instruction to fulfill user requirements. In this way, use complexity is increased, and user experience of using a speech recognition device is degraded.

### SUMMARY

The disclosure provides a method and apparatus for controlling a speech recognition device, an electronic device, and a storage medium, so as to solve a problem of a complicated awakening mode of a speech device in the related art.

According to a first aspect, some embodiments of the disclosure provide a method for controlling a speech recognition device. The method includes: recording, when the speech recognition device is in a dormant state, current time as first time in response to detecting that a target object stares at the speech recognition device; recording the current time as second time in response to detecting that the target object makes a speech; and awakening the speech recognition device in response to determining that an interval between the first time and the second time satisfies a preset condition, such that the speech recognition device enters a speech control mode.

According to a second aspect, the disclosure provides an apparatus for controlling a speech recognition device. The apparatus includes: a first recording module configured to record, when the speech recognition device is in a dormant state, current time as first time in response to detecting that a target object stares at the speech recognition device; a second recording module configured to record the current time as second time in response to detecting that the target object makes a speech; and a first awakening module configured to awaken the speech recognition device in response to determining that an interval between the first time and the second time satisfies a preset condition, such that the speech recognition device enters a speech control mode.

According to a third aspect, the disclosure provides an electronic device. The electronic device includes a processor, a communication interface, a memory, and a communication bus. The processor, the communication interface and the memory are in communication with one another through the communication bus.

The memory is configured to store a computer program.

The processor is configured to execute the computer program stored in the memory, so as to implement steps of the method for controlling a speech recognition device according to the first aspect.

According to a fourth aspect, the disclosure provides a computer-readable storage medium, which stores a computer program. The computer program implements steps of the method for controlling a speech recognition device according to the first aspect when being executed by a processor.

Compared with the related art, the technical solution according to the example of the disclosure has the following advantages:

According to the method of the examples of the disclosure, firstly, when the speech recognition device is in the dormant state, the current time is recorded as the first time in response to detecting that the target object stares at the speech recognition device; then, the current time is recorded as the second time in response to detecting that the target object makes the speech; and finally, the speech recognition device is awakened in response to determining that the interval between the first time and the second time satisfies the preset condition, such that the speech recognition device enters the speech control mode. According to the method, the speech recognition device is awakened according to an interval between time when the target object stares at the speech recognition device and time when the speech is made, and the target object does not need to firstly say a wakeup word to awaken the speech recognition device. In this way, complexity of awakening a speech device is reduced, user experience is improved, and further a problem of a complicated awakening mode of the speech device in the related art is solved.

### BRIEF DESCRIPTION OF THE DRAWINGS

Accompanying drawings herein are incorporated in the description as a constituent part of the description, illustrate examples conforming to the disclosure, and serve to describe principles of the disclosure together with the description.

To more clearly describe technical solutions in examples of the disclosure or in the related art, the accompanying drawings required for description of the examples or the related art will be briefly introduced below. Obviously, those of ordinary skill in the art can also derive other accompanying drawings from these accompanying drawings without making inventive efforts.

FIG. 1 illustrates a schematic flow diagram of a method for controlling a speech recognition device according to an example of the disclosure;

FIG. 2 illustrates a schematic flow diagram of a method for controlling a speech recognition device according to an example of the disclosure;

FIG. 3 illustrates a schematic structural diagram of an apparatus for controlling a speech recognition device according to an example of the disclosure; and

FIG. 4 illustrates a schematic structural diagram of an electronic device according to an example of the disclosure.

### DETAILED DESCRIPTION OF THE EMBODIMENTS

For making objectives, technical solutions and advantages of examples of the disclosure more obvious, the technical solutions in the examples of the disclosure will be clearly and completely described below in conjunction with the accompanying drawings in the examples of the disclosure. Obviously, the described examples are some examples rather than all examples of the disclosure. On the basis of the examples of the disclosure, all other examples obtained by those of ordinary skill in the art without making creative efforts fall within the protection scope of the disclosure.

An aspect of an example of the disclosure provides a method for controlling a speech recognition device. In some embodiments, the method for controlling a speech recognition device is applied to a hardware environment consisting of a terminal and a server. The server is connected with the terminal through a network, and is configured to provide services for the terminal or a client configured on the terminal. A database is configured on the server or independently of the server, and is configured to provide a data storage service for the server.

The network includes, but is not limited to, at least one of the following: a wired network and a wireless network. The wired network include,

but is not limited to, at least one of the following: a wide area network, a metropolitan area network, and a local area network. The wireless network includes, but is not limited to, at least one of the following: wireless fidelity (WIFI) and Bluetooth. The terminal is limited to a personal computer (PC), a mobile phone, a tablet computer, etc.

The method for controlling a speech recognition device according to the example of the disclosure is executed by the server, or by the terminal, or jointly by the server and the terminal. The method for controlling a speech recognition device according to the example of the disclosure is executed by the terminal or the client configured on the terminal.

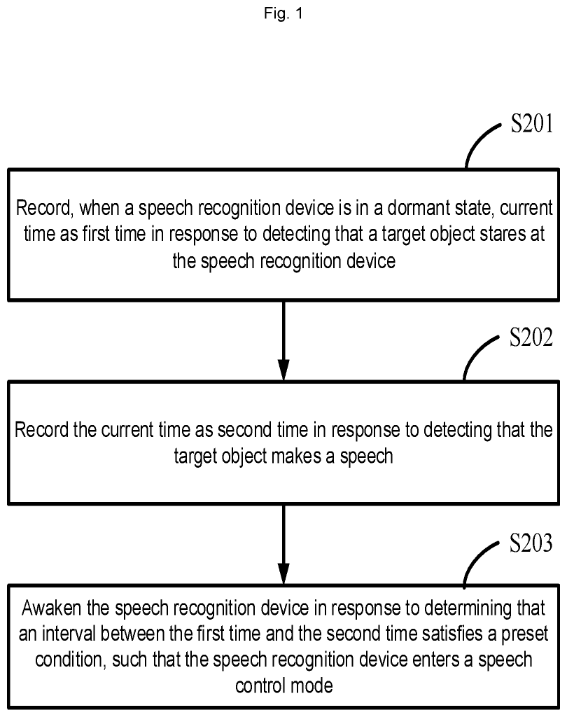

For instance, in a case that the method for controlling a speech recognition device according to the example is executed by the server, FIG. 1 is a schematic flow diagram of a method for controlling a speech recognition device according to an example of the disclosure. As shown in FIG. 1, the method includes the following steps:

S201, when the speech recognition device is in a dormant state, current time is recorded as first time in response to detecting that a target object stares at the speech recognition device.

In the example, the speech recognition device is a smart speaker, a television or another household appliance. Operation states of the speech recognition device include the dormant state and a working state. When the speech recognition device is in the dormant state, the speech recognition device is in the working state only after the speech recognition device is awakened. When the speech recognition device is in the working state, the speech recognition device does not need to be awakened, and directly receive a speech of a user and execute a corresponding control instruction according to the speech of the user.

According to communication habits between people, they often stare at each other when communicating with others. Accordingly, people generally keep the habit when communicating with a speech device. When a user transmits an instruction to an intelligent speech recognition device, the user also stares at the device, so the current time when the user stares at the speech recognition device needs to be recorded.

S202, the current time is recorded as second time in response to detecting that the target object makes a speech.

In the example, whether the target object makes the speech is detected by a speech detection module in the speech recognition device. Even if the speech recognition device is in the dormant state, whether the target object makes the speech is detected all the time by the speech detection module in the speech recognition device.

S203, the speech recognition device is awakened in response to determining that an interval between the first time and the second time satisfies a preset condition, such that the speech recognition device enters a speech control mode.

In the example, the speech control mode is the working state of the speech recognition device. In response to determining that the interval between the first time and the second time does not satisfy the preset condition, the speech recognition device awakens the speech recognition device according to whether a wakeup word exists in the speech made by the target object. In this way, assistance is provided for a determination method with an interval between staring time and time when the speech is made, occurrence of missed determination is avoided, and further accuracy of awakening the speech recognition device is improved.

In an example, after the speech recognition device is awakened, the method further includes the following steps: whether a preset target keyword exists in the speech is detected; and the speech recognition device is controlled to execute an operation corresponding to the preset target keyword in response to detecting that the preset target keyword exists in the speech, and the speech recognition device is controlled to be switched to the dormant state in response to detecting that the preset target keyword does not exist in the speech.

In the example, after the speech recognition device is awakened, the target keyword in the speech is detected by the speech detection module. If the target keyword exists in the speech, intelligent speech recognition is controlled according to a control instruction corresponding to the target keyword, such that the speech recognition device is accurately controlled. Control of the speech recognition device of the example is based on the awakening mode of the disclosure. A user does not need to firstly say the wakeup word to awaken the speech recognition device and then control the speech recognition device, and control the speech recognition device while staring at the speech recognition device. In this way, it is more convenient for the user to use the intelligent speech recognition device, and user experience is greatly improved.

In practical application, a keyword of the speech made by the target object is retrieved through any speech keyword retrieval technology. For instance, the keyword of the speech made by the target object is retrieved through a deep neural network. After the target keyword is retrieved, whether the speech is made to the speech recognition device needs to be determined according to a meaning of the speech made by the user. In this way, false recognition of the speech recognition device is avoided, accuracy of user control is improved, and further user experience is improved.

In an example, the step that the speech recognition device is awakened in response to determining that the interval between the first time and the second time satisfies the preset condition includes the following step: in response to determining that the interval is shorter than or equal to a first predetermined value, it is determined that the target object has an intention to control the speech recognition device, and the speech recognition device is awakened.

On the basis of a user habit in use of the speech recognition device, when a user has an intention to use the speech recognition device, the user generally makes a speech soon after staring at the speech recognition device. Therefore, in the example, in response to determining that the interval is shorter than or equal to the first predetermined value, it is considered that the user has an intention to control the speech recognition device, and the speech recognition device is awakened.

The first predetermined value is determined by collecting big data and experiments to determine duration from time the user starts to stare at the device to time the user no longer has an intention to say a word to communicate with the device when the user uses the speech recognition device. In this way, control accuracy can be further improved.

Clearly, in practical application, whether the user has the intention to control the speech recognition device is determined according to the interval between start time when the user stares at the speech recognition device and the time when the speech is made, or other duration, such that determination accuracy can be further improved. In an example, the step that the speech recognition device is awakened in response to determining that the interval between the first time and the second time satisfies the preset condition includes the following step: in response to detecting that speech duration corresponding to the speech is shorter than or equal to a third predetermined value, it is determined that the target object has an intention to control the speech recognition device in response to determining that the interval is shorter than or equal to a second predetermined value, and the speech recognition device is awakened.

The user is chatting with other people in a space while staring at the speech recognition device, which cause false wakeup. Therefore, in the example, when the interval is shorter than or equal to the second predetermined value, duration of the speech made by the target object needs to be measured. If the speech duration of the user is longer than the third predetermined value, it is considered that the user is chatting with other people and has no intention to control the speech recognition device. If the speech duration of the user is shorter than or equal to the third predetermined value, it is considered that the user has the intention to control the speech recognition device.

A method for determining the second predetermined value and the third predetermined value is consistent with a method for determining the first predetermined value. Big data and experiments are collected to determine duration from time the user starts to stare at the device to time the user no longer has the intention to say a word to communicate with the device when the user uses the speech recognition device and a length of a sentence after staring.

In a specific example, whether the user has the intention to control the speech recognition device is determined according to duration of staring at the speech recognition device by the user.

In an example, the method further includes the following steps: a monitoring function of the speech recognition device is enabled in response to detecting that the target object does not stare at the speech recognition device; whether a preset wakeup word exists in the speech is monitored in response to monitoring that the target object makes the speech; the speech recognition device is awakened in response to determining that the preset wakeup word exists in the speech; an audio clip in the speech except an audio clip corresponding to the preset wakeup word is used as a target speech; semantic analysis is conducted on the target speech, and whether a preset target keyword exists in the target speech is determined; and the speech recognition device is controlled to operate according to a control instruction corresponding to the target keyword in response to determining that the target keyword exists in the target speech, and the speech recognition device is controlled to be switched to the dormant state in response to determining that the target keyword does not exist in the target speech.

In the example, in response to detecting that the target object does not stare at the speech recognition device, a monitoring function of an intelligent speech device is enabled to monitor whether the wakeup word exists in the speech made by the user. If the wakeup word exists, the speech recognition device is awakened. In the example, no matter where the wakeup word is located in the speech (for instance, “turn on the air conditioner, Xiaoming” or “Xiaoming, turn on the air conditioner”), the speech recognition device is awakened. Then, speech analysis is conducted according to parts other than the wakeup word. The speech recognition device is controlled if the target keyword exists, such that convenience and practicability of the speech recognition device can be improved.

In practical application, the monitoring function is not only available when the user does not stare at the speech recognition device, and enabled all the time during use of the speech recognition device. As long as a wakeup word exists in the speech made by the user, the speech recognition device is awakened regardless of whether an interval between staring time and speech making time satisfies a condition. For instance, according to the first time and the second time of the user, in response to analyzing that the user has no intention to control the speech recognition device, whether the wakeup word exists in the speech made by the user is monitored, such that the device is awakened. Alternatively, according to the first time and the second time of the user, in response to analyzing that the user has the intention to control the speech recognition device and monitoring that the wakeup word exists in the speech made by the user, such that the device is awakened.

In an example, the steps that semantic analysis is conducted on the target speech, and whether the preset target keyword exists in the target speech is determined include the following steps: the target speech is decoded through a speech recognition model, and a candidate word sequence is obtained, where the speech recognition model is configured to convert the target speech into text data; a word grid is generated according to the candidate word sequence, a backtracking path corresponding to the candidate word sequence, and a matched score corresponding to the candidate word sequence; a word spelling in the word grid is retrieved according to a spelling of the preset target keyword, and a retrieval result is obtained; and it is determined that the preset target keyword exists in the target speech in response to determining that the word spelling of the preset target keyword exists in the retrieval result.

In the example, the target speech is analyzed through decoding, and whether a keyword exists in the target speech is determined, such that a more accurate control result is obtained. Clearly, in practical application, semantic analysis may be conducted on the target speech in other ways, such as a neural network mentioned in the above content. Those skilled in the art select a proper way according to an actual situation.

In an example, the speech recognition device is provided with an eyeball tracking device. The step that the current time is recorded as the first time in response to detecting that the target object stares at the speech recognition device includes the following steps: a fall point of light reflected by an eyeball of the target object on the eyeball tracking device is obtained in response to determining that the eyeball tracking device emits light; a line-of-sight center of the target object is determined according to the fall point, eyeball shape information of the target object and a distance from the target object to the eyeball tracking device; and in response to determining that the line-of-sight center of the target object is located in a spatial zone where the speech recognition device is located, it is determined that the target object stares at the speech recognition device, and the current time is recorded as the first time.

In response to determining that two speech recognition devices exists in the space and the two speech recognition devices are close to each other, eyeball tracking devices of the two devices both detect eyeballs of the user. If the user is considered to stare at the device only by detecting the eyeball of the user, the device that the user has no intention to control is awakened. Therefore, in the example, the line-of-sight center of the user needs to be determined firstly. If the line-of-sight center of the user is on the speech recognition device, it is determined that the user stares at the speech recognition device. In this way, accuracy of awakening the speech device can be improved.

The eyeball tracking device is an infrared device or an image collection device, such as a camera. The eyeball shape information is collected when the user uses the speech recognition device for the first time.

The technical solution of the disclosure will be further described in detail below in conjunction with specific embodiments.

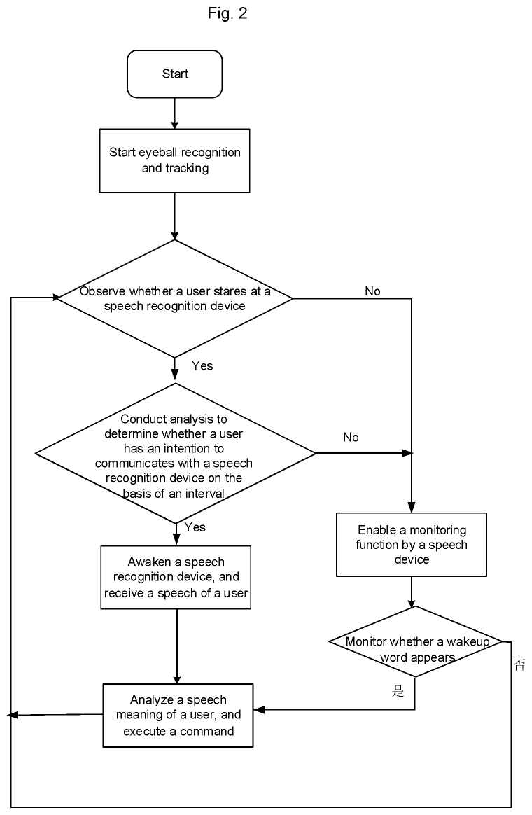

FIG. 2 is a schematic flow diagram of a method for controlling a speech recognition device according to an example of the disclosure. As shown in FIG. 2, the method includes the following steps:

Step 1, eyeball recognition and tracking is started: an eyeball of a user is tracked through an eyeball tracking device on the speech recognition device.

Step 2, whether the user stares at the speech recognition device is observed, if the user stares at the speech recognition device, current time is recorded as the first time, whether the user has an intention to communicate with the speech recognition device is analyzed, and if the user does not stare at the speech recognition device, a monitoring function is enabled.

Step 3, whether the user has a communication intention is determined according to an interval between the first time and the second time when the user makes a speech, if the interval is shorter than or equal to the first predetermined value, it is considered that the user has the communication intention, and if the interval is longer than the first predetermined value, the monitoring function is enabled.

When the user has the communication intention, the following steps are executed:

Step 4, when the user has the communication intention, a speech device is awakened, and a speech of a user is received.

Step 5, a meaning of the speech of the user is analyzed, and the speech recognition device is controlled to execute a corresponding instruction in response to determining that the target keyword exists in the speech of the user.

When the user has no communication intention or the user does not stare at the speech recognition device, the following steps are executed:

Step 6, when the monitoring function is enabled, whether a wakeup word appears in the speech of the user is monitored.

Step 7, a meaning of the speech except the wakeup word is analyzed, and the speech recognition device is controlled to execute a corresponding instruction in response to determining that a target keyword exists in the speech of the user.

According to the method for controlling a speech recognition device in all the examples, on the basis of the same inventive concept, the example further provides an apparatus for controlling a speech recognition device. The apparatus is configured to implement the examples and preferred embodiments, which will not be repeated herein. The term “module”, as used below, achieves a combination of software and/or hardware having predetermined functions. While the apparatus described in the following examples is preferably achieved in software, achievement of hardware, or a combination of software and hardware, is also possible and conceivable.

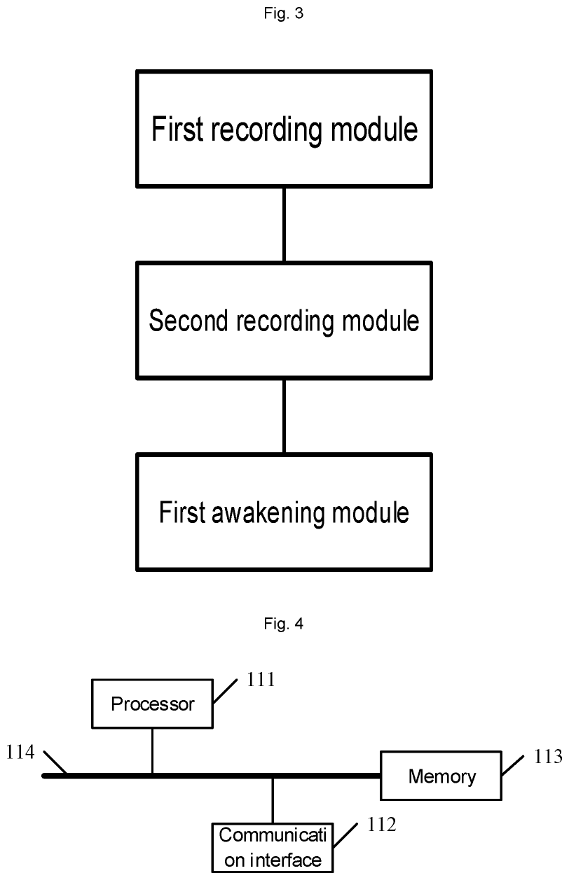

FIG. 3 is a schematic structural diagram of an apparatus for controlling a speech recognition device according to an example of the disclosure. As shown in FIG. 3, the apparatus includes:

a first recording module 10 configured to record, when the speech recognition device is in a dormant state, current time as first time in response to detecting that a target object stares at the speech recognition device;

a second recording module 20 configured to record the current time as second time in response to detecting that the target object makes a speech; and

a first awakening module 30 configured to awaken the speech recognition device in response to determining that an interval between the first time and the second time satisfies a preset condition, such that the speech recognition device enters a speech control mode.

In an example, the apparatus further includes a speech detection module and a first control module. The speech detection module is configured to detect, after awakening the speech recognition device, whether a preset target keyword exists in the speech through the speech detection module. The first control module is configured to control the speech recognition device to execute an operation corresponding to the target keyword in response to detecting that the target keyword exists in the speech, and control the speech recognition device to be switched to the dormant state in response to detecting that the target keyword does not exist in the speech.

In an example, the first awakening module 30 includes a first awakening sub-module. The first awakening sub-module is configured to determine, in response to determining that the interval is shorter than or equal to the first predetermined value, that the target object has an intention to control the speech recognition device, and awaken the speech recognition device.

In an example, the first awakening module 30 includes a second awakening sub-module. The second awakening sub-module is configured to determine, in response to detecting that speech duration corresponding to the speech is shorter than or equal to the third predetermined value, that the target object has an intention to control the speech recognition device in response to determining that the interval is shorter than or equal to a second predetermined value, and awaken the speech recognition device.

In an example, the apparatus further includes an enabling module, a monitoring module, a second awakening module, a determination module, an analysis module, and a second control module. The enabling module is configured to enable a monitoring function of the speech recognition device in response to detecting that the target object does not stare at the speech recognition device. The monitoring module is configured to enable, when the speech recognition device is in the dormant state, the monitoring function of the speech recognition device in response to detecting that the target object does not stare at the speech recognition device, and monitor whether a preset wakeup word exists in the speech in response to monitoring that the target object makes the speech. The second awakening module is configured to awaken the speech recognition device in response to determining that the wakeup word exists in the speech. The determination module is configured to use the audio clip in the speech except the audio clip corresponding to the wakeup word as a target speech. The analysis module is configured to conduct semantic analysis on the target speech, and determine whether the preset target keyword exists in the target speech. The second control module is configured to control the speech recognition device to operate according to a control instruction corresponding to the target keyword in response to determining that the target keyword exists in the target speech, and control the speech recognition device to be switched to the dormant state in response to determining that the target keyword does not exist in the target speech.

In an example, the analysis module includes a decoding sub-module, a generation sub-module, a retrieval sub-module, and a first determination sub-module. The decoding sub-module is configured to decode the target speech through a speech recognition model, and obtain the candidate word sequence, where the speech recognition model is configured to convert the target speech into text data. The generation sub-module is configured to generate the word grid according to the candidate word sequence, the backtracking path corresponding to the candidate word sequence, and the matched score corresponding to the candidate word sequence. The retrieval sub-module is configured to retrieve the word spelling in the word grid according to a spelling of the target keyword, and obtain a retrieval result. The first determination sub-module is configured to determine that the target keyword exists in the target speech in response to determining that the word spelling of the target keyword exists in the retrieval result.

In an example, the speech recognition device is provided with the eyeball tracking device. The first recording module 10 includes an obtaining sub-module, a second determination sub-module, and a third determination sub-module. The obtaining sub-module is configured to obtain the fall point of light reflected by the eyeball of the target object on the eyeball tracking device in response to determining that the eyeball tracking device emits light. The second determination sub-module is configured to determine the line-of-sight center of the target object according to the fall point, eyeball shape information of the target object and the distance from the target object to the eyeball tracking device. The third determination sub-module is configured to determine, in response to determining that the line-of-sight center of the target object is located in the spatial zone where the speech recognition device is located, that the target object stares at the speech recognition device, and record the current time as the first time.

It should be noted that all the modules is implemented by software or hardware, implementation by hardware is implemented as follows, but are not limited thereto: the modules are located in a same processor; or the modules are separately located in different processors in any combination form.

As shown in FIG. 4, an example of the disclosure provides an electronic device. The electronic device includes a processor 111, a communication interface 112, a memory 113, and a communication bus 114. The processor 111, the communication interface 112 and the memory 113 are in communication with one another through the communication bus 114.

The memory 113 is configured to store a computer program.

In an example of the disclosure, the processor 111 is configured to execute the computer program stored in the memory 113, so as to implement the method for controlling a speech recognition device according to any method example.

An example of the disclosure further provides a computer-readable storage medium, which stores a computer program. The computer program implements steps of the method for controlling a speech recognition device according to any method example when being executed by a processor.

It should be noted that relational terms herein such as “first” and “second” are only used to distinguish one entity or operation from another entity or operation without necessarily requiring or implying any actual such relation or order between such entities or operations. In addition, terms “include”, “comprise”, “involve”, or any other variations thereof are intended to cover non-exclusive inclusions, such that a process, a method, an article, or a device including a series of elements not only includes those elements, but also includes other elements that are not explicitly listed, or also includes inherent elements of the process, the method, the article, or the device. Without more restrictions, the elements defined by the phrase “including a . . . ” or “comprising a . . . ” do not exclude the existence of other identical elements in the process, method, article, or device including the elements.

What are described above are only specific embodiments of the disclosure, such that those skilled in the art can understand or implement the disclosure. Various modifications to the examples are readily obvious to those skilled in the art, and the general principles defined herein can be implemented in other examples without departing from the spirit or scope of the disclosure. Therefore, the disclosure is not limited to the examples shown herein but conforms to the widest scope consistent with the principles and novel features disclosed herein.

What is claimed is:

1. A method for controlling a speech recognition device, comprising:
recording, when the speech recognition device is in a dormant state, current time as first time in response to detecting that a target object stares at the speech recognition device;
recording the current time as second time in response to detecting that the target object makes a speech; and
awakening the speech recognition device in response to determining that an interval between the first time and the second time satisfies a preset condition, such that the speech recognition device enters a speech control mode.

2. The method as claimed in claim 1, wherein after the awakening the speech recognition device, the method further comprises:
detecting whether a preset target keyword exists in the speech; and
controlling the speech recognition device to execute an operation corresponding to the preset target keyword in response to detecting that the preset target keyword exists in the speech, and controlling the speech recognition device to be switched to the dormant state in response to detecting that the preset target keyword does not exist in the speech.

3. The method as claimed in claim 1, wherein the awakening the speech recognition device in response to determining that an interval between the first time and the second time satisfies a preset condition comprises:
determining, in response to determining that the interval is shorter than or equal to a first predetermined value, that the target object has an intention to control the speech recognition device, and awakening the speech recognition device.

4. The method as claimed in claim 1, wherein the awakening the speech recognition device in response to determining that an interval between the first time and the second time satisfies the preset condition comprises:
determining, in response to detecting that speech duration corresponding to the speech is shorter than or equal to a third predetermined value, that the target object has an intention to control the speech recognition device in response to determining that the interval is shorter than or equal to a second predetermined value, and awakening the speech recognition device.

5. The method as claimed in claim 1, further comprising:
enabling a monitoring function of the speech recognition device in response to detecting that the target object does not stare at the speech recognition device;
detecting whether a preset wakeup word exists in the speech in response to monitoring that the target object makes the speech;
awakening the speech recognition device in response to determining that the preset wakeup word exists in the speech;
using an audio clip in the speech except an audio clip corresponding to the preset wakeup word as a target speech, conducting semantic analysis on the target speech, and determining whether a preset target keyword exists in the target speech; and
controlling the speech recognition device to operate according to a control instruction corresponding to the target keyword in response to determining that the preset target keyword exists in the target speech, and controlling the speech recognition device to be switched to the dormant state in response to determining that the preset target keyword does not exist in the target speech.

6. The method as claimed in claim 5, wherein the conducting semantic analysis on the target speech, and determining whether the preset target keyword exists in the target speech comprise:
decoding the target speech through a speech recognition model, and obtaining a candidate word sequence, wherein the speech recognition model is configured to convert the target speech into text data;
generating a word grid according to the candidate word sequence, a backtracking path corresponding to the candidate word sequence, and a matched score corresponding to the candidate word sequence;
retrieving a word spelling in the word grid according to a spelling of the preset target keyword, and obtaining a retrieval result; and
determining that the preset target keyword exists in the target speech in response to determining that the word spelling of the preset target keyword exists in the retrieval result.

7. The method as claimed in claim 1, wherein the speech recognition device is provided with an eyeball tracking device, and the recording current time as the first time in response to detecting that the target object stares at the speech recognition device comprises:
obtaining a fall point of light reflected by an eyeball of the target object on the eyeball tracking device in response to determining that the eyeball tracking device emits light;
determining a line-of-sight center of the target object according to the fall point, eyeball shape information of the target object and a distance from the target object to the eyeball tracking device; and
determining, in response to determining that the line-of-sight center of the target object is located in a spatial zone where the speech recognition device is located, that the target object stares at the speech recognition device, and recording the current time as the first time.

8. An apparatus for controlling a speech recognition device, comprising:
a first recording module configured to record, when the speech recognition device is in a dormant state, current time as first time in response to detecting that a target object stares at the speech recognition device;
a second recording module configured to record the current time as second time in response to detecting that the target object makes a speech; and
a first awakening module configured to awaken the speech recognition device in response to determining that an interval between the first time and the second time satisfies a preset condition, such that the speech recognition device enters a speech control mode.

9. An electronic device, comprising a processor, a communication interface, a memory, and a communication bus, wherein the processor, the communication interface and the memory are in communication with one another through the communication bus;
the memory is configured to store a computer program; and
the processor is configured to execute the computer program stored in the memory, so as to implement steps of the method for controlling a speech recognition device as claimed in claim 1.

10. The electronic device as claimed in claim 9, wherein after the awakening the speech recognition device, the method further comprises:
detecting whether a preset target keyword exists in the speech; and
controlling the speech recognition device to execute an operation corresponding to the preset target keyword in response to detecting that the preset target keyword exists in the speech, and controlling the speech recognition device to be switched to the dormant state in response to detecting that the preset target keyword does not exist in the speech.

11. The electronic device as claimed in claim 9, wherein the awakening the speech recognition device in response to determining that an interval between the first time and the second time satisfies a preset condition comprises:
determining, in response to determining that the interval is shorter than or equal to a first predetermined value, that the target object has an intention to control the speech recognition device, and awakening the speech recognition device.

12. The electronic device as claimed in claim 9, wherein the awakening the speech recognition device in response to determining that an interval between the first time and the second time satisfies the preset condition comprises:
determining, in response to detecting that speech duration corresponding to the speech is shorter than or equal to a third predetermined value, that the target object has an intention to control the speech recognition device in response to determining that the interval is shorter than or equal to a second predetermined value, and awakening the speech recognition device.

13. The electronic device as claimed in claim 9, further comprising:
enabling a monitoring function of the speech recognition device in response to detecting that the target object does not stare at the speech recognition device;
detecting whether a preset wakeup word exists in the speech in response to monitoring that the target object makes the speech;
awakening the speech recognition device in response to determining that the preset wakeup word exists in the speech;
using an audio clip in the speech except an audio clip corresponding to the preset wakeup word as a target speech, conducting semantic analysis on the target speech, and determining whether a preset target keyword exists in the target speech; and
controlling the speech recognition device to operate according to a control instruction corresponding to the target keyword in response to determining that the preset target keyword exists in the target speech, and controlling the speech recognition device to be switched to the dormant state in response to determining that the preset target keyword does not exist in the target speech.

14. A computer-readable storage medium, storing a computer program, wherein the computer program implements steps of the method for controlling a speech recognition device as claimed in claim 1 when being executed by a processor.

15. The computer-readable storage medium as claimed in claim 14, wherein after the awakening the speech recognition device, the method further comprises:
detecting whether a preset target keyword exists in the speech; and
controlling the speech recognition device to execute an operation corresponding to the preset target keyword in response to detecting that the preset target keyword exists in the speech, and controlling the speech recognition device to be switched to the dormant state in response to detecting that the preset target keyword does not exist in the speech.

16. The computer-readable storage medium as claimed in claim 14, wherein the awakening the speech recognition device in response to determining that an interval between the first time and the second time satisfies a preset condition comprises:
determining, in response to determining that the interval is shorter than or equal to a first predetermined value, that the target object has an intention to control the speech recognition device, and awakening the speech recognition device.

17. The computer-readable storage medium as claimed in claim 14, wherein the speech recognition device is provided with an eyeball tracking device, and the recording current time as the first time in response to detecting that the target object stares at the speech recognition device comprises:
obtaining a fall point of light reflected by an eyeball of the target object on the eyeball tracking device in response to determining that the eyeball tracking device emits light;
determining a line-of-sight center of the target object according to the fall point, eyeball shape information of the target object and a distance from the target object to the eyeball tracking device; and
determining, in response to determining that the line-of-sight center of the target object is located in a spatial zone where the speech recognition device is located, that the target object stares at the speech recognition device, and recording the current time as the first time.

18. The apparatus for controlling a speech recognition device as claimed in claim 8, wherein the apparatus for controlling a speech recognition device comprises:
a speech detection module, configured to detect after awakening the speech recognition device, whether a preset target keyword exists in the speech;
a first control module, configured to control the speech recognition device to execute an operation corresponding to a target keyword in response to detecting that the target keyword exists in the speech, and control the speech recognition device to be switched to the dormant state in response to detecting that the target keyword does not exist in the speech.

19. The apparatus for controlling a speech recognition device as claimed in claim 8, wherein
the first awakening module comprises a first awakening sub-module, the first awakening sub-module is configured to determine, in response to determining that the interval is shorter than or equal to a first predetermined value, that the target object has an intention to control the speech recognition device, and awaken the speech recognition device.

20. The apparatus for controlling a speech recognition device as claimed in claim 8, wherein
the first awakening module comprises a second awakening sub-module, the second awakening sub-module is configured to determine, in response to detecting that speech duration corresponding to the speech is shorter than or equal to a third predetermined value, that the target object has an intention to control the speech recognition device in response to determining that the interval is shorter than or equal to a second predetermined value, and awaken the speech recognition device.
